(19) United States
(12) Patent Application Publication
(10) Pub. No.: US 2004/0219265 A1
(43) Pub. Date: Nov. 4, 2004

(54) Alcoholic Popsicle-style frozen confection/beverage

(75) Inventor: Scott Purcell, Newport Beach, CA (US)

Correspondence Address: McDermott, Will & Emery, 600 13th Street, N.W., Washington, DC, 20005-3096, US

(73) Assignee: ARCTIC ISLAND, LLC, Newport Beach, CA

(21) Appl. No.: 10/702,078

(22) Filed: Nov. 6, 2003

Related U.S. Application Data
(63) Continuation of application No. 10/153,221, filed on May 23, 2002, now abandoned.

(51) Int. Cl. A23G 1/00

(52) U.S. Cl. 426/134

(57) ABSTRACT

Alcoholic water ices containing ethyl alcohol found in comestible alcohols such as beer, wine, liquor, alcoholic cocktails or other types of spirits creating Popsicle-style alcoholic frozen confections and frozen beverages.

### FIELD OF THE INVENTION

The present invention relates to a frozen confection or frozen beverage containing any formulation of comestible ethyl alcohol combined with water, sweetener, stabilizers, flavorings and other ingredients together to create an alcoholic Popsicle-style water ice having pleasing organoleptic properties including flavored to taste like an alcoholic beverage, Popsicle-type consistency and hardness as well as a pleasing mouth feel.

### BACKGROUND OF THE INVENTION

The Popsicle® and its variants have long been favorite summertime refreshments for people of all ages. The original idea for a Popsicle® was patented in 1923 by Frank Epperson as the “Epsicle.” In 1905 Epperson stumbled on the idea by accident at age eleven. Published accounts state that one evening young Epperson had mixed up a batch of soda water powder and water, a then-popular beverage, and left the concoction on his back porch with the stirring stick still in it. It was a cold night, dropping below freezing. The next morning Epperson woke to find the frozen product stuck to his stirring stick. The idea stayed with him and years later, Frank Epperson, realizing the commercial value of his discovery launched his Popsicle® dynasty.

From that time until now many advancements and refinements have occurred in the Popsicle® and frozen confection industry including name brand treats such as the Fudgsicle®, Creamsicle®, Sidewalk Sundaes, etc. Advances in manufacturing technology and food science are apparent in the products that are multi-colored, multi-flavored, multi-textured, low fat, low calorie, and many other organoleptic and visual properties that are pleasing.

Much like the Popsicle®, frozen cocktails have long been a favorite beverage for adults 21 and over at bars, cocktail lounges, resorts and restaurants. Drinks such as frozen margaritas, strawberry daiquiris and other slush-style alcohol beverages are often the preferred cocktail for adults.

These cocktails are typically referred to as “frozen cocktails,” but it would be more apt to describe them as slushes: mixtures of liquid alcohol, flavorings, and small granular ice crystals.

Completely freezing alcoholic beverages to enjoy in frozen form can be problematic due to the low freezing point of ethyl alcohol, the alcohol in comestible alcohols. Water freezes at 32° F. By way of comparison pure ethyl alcohol freezes at a much lower temperature, typically at −179° F. under normal atmospheric conditions and pressures. Alcoholic beverages and cocktails characteristically will freeze somewhere in between the freezing temperatures for water and ethyl alcohol, depending largely on the percentage of alcohol present in the mixture. If that freezing point is too low, the manufacture, distribution and consumption of completely frozen alcoholic confections become impractical.

More specifically, the freezing point of comestible alcohols and cocktails depends largely on the percentage of alcohol contained, but this dependence does not interpolate linearly: beer and wine will freeze at temperatures somewhere around 14° F. whereas higher proof alcohols such as vodka and gin freeze at much lower temperatures. Additionally, the lower the freezing point of an alcoholic mixture, the greater the difficulty in freezing it homogeneously. If not frozen quickly and uniformly, ice crystals will form first, effectively concentrating the alcohol and other ingredients heterogeneous fashion. Therefore, as the freezing point temperature falls, the production of homogenous frozen alcoholic confections becomes increasing problematic.

Nonetheless, the art has sought to provide frozen alcoholic beverages. For example, U.S. Pat. No. 3,350,712 to Kocharian, et al, discloses a frozen beverage stick including an insulated retractable cup that slows melting, prevents dripping, and catches the melting frozen beer or wine for easy consumption. U.S. Pat. No. 5,296,251 to Ishida, et al, discloses a method for super cooling sake under pressure and below the freezing point of sake. The super-cooled sake only freezes when poured into a glass or cup under normal atmospheric conditions and pressures. The resultant product is sherbet-like in texture, consumed with a spoon. U.S. Pat. No. 4,790,999 to Ashmont, et al, discloses a freeze-thaw stable and ready-to-freeze alcoholic beverage made of sugars, alcohol, flavorings and a carboxymethlycellulose stabilizer. The carboxymethlycellulose stabilizer used is present in concentrations between 0.02% and 0.1% by weight. The frozen product is a deformable and spoonable soft ice either to be consumed directly from the container or served into a container for a slush-style cocktail.

None of these references, however, cite the preparation of an alcoholic frozen confection or frozen beverage with a consistency, uniformity, stability and degree of hardness necessary for the formation of a Popsicle-style product. Furthermore, none of these references disclose the formation of such a frozen alcoholic confection or frozen beverage with pleasing Popsicle-like organoleptic properties. Nor do the references disclose an alcoholic frozen confection or frozen beverage produced using mass-production manufacturing techniques for Popsicle-style confections.

Accordingly, there remains a need for an alcoholic Popsicle-style frozen confection or frozen beverage. Such a formulation can be used in creating any number of Popsicle-style products using conventional mass-production techniques for Popsicle-type products and related frozen confections or frozen beverages. Additionally, it would be highly desirable for the alcoholic frozen confection or frozen beverage to have pleasing organoleptic properties akin to the archetypal Popsicle® in terms of pleasant mouth feel, slow melting and drip characteristics, easily crushed with the teeth but having a consistency, uniformity, stability and degree of hardness consistent with Popsicles.

### SUMMARY OF THE INVENTION

The invention provides alcoholic Popsicle-style water ices formulated with water, flavorings, any class or combination of sweeteners, ethyl alcohol from any selection or combination of comestible alcohols, an acidulant, an emulsifier and a gum-based stabilizer. The proof of the alcohol mixture ranges between 4 and 28. The stabilizer can be one or a combination of gum stabilizers including but not limited to Locust Bean Gum, Agar-Agar, xanthan gum, cellulose gum, Algin-sodium alginate, propylene glycol alginate, Gum acacia, Guar seed gum, pectin, gum karaya, cat gum, gum tragacanth, and carrageenan. The gum stabilizer is present in an amount ranging from 0.001% to 1.0% by weight, more preferably between 0.01% to 0.5% by weight, and most preferably between 0.1% and 0.3%. The alcoholic Popsicle-style water ice is manufactured using conventional manufacturing techniques for Popsicle-style products and freezes somewhere between −5° Fahrenheit and −50° Fahrenheit, more preferably between −15° Fahrenheit and −40° Fahrenheit and most preferably between −20° Fahrenheit and −30° Fahrenheit. Included in the manufacture of the alcoholic Popsicle-style product is a conventional Popsicle® stick, made of wood, plastic or other materials used in the art of Popsicle-style confection production.

The alcoholic Popsicle-style product can be formulated in a variety of configurations, flavors, styles and forms to take advantage of the advances in conventional frozen confection manufacturing technology. Examples include but are not limited to multi-color and multi-flavor alcoholic Popsicle-style products as well multi-layered alcoholic Popsicle-style products that change color and flavor from the outside in to the center. Alcoholic Popsicle-style products are stable to process, transport and store at approximately 0° F. or lower and must be kept frozen until consumption.

Additional objects and attendant advantages of the present invention will be set forth, in part, in the description that follows, or may be learned from practicing or using the present invention. The objects and advantages may be realized and attained by means of the instrumentalities and combinations particularly pointed out in the appended claims. It is to be understood that the foregoing general description and the following detailed description are exemplary and explanatory only and are not to be viewed as being restrictive of the invention, as claimed.

### DESCRIPTION OF PREFERRED EMBODIMENTS

All patents, patent applications and literatures cited in this description are incorporated herein by reference in their entirety. In the case of inconsistencies, the present disclosure, including definitions, will prevail.

Before proceeding with a description of the specific embodiments of the present invention, a number of terms will be defined. Throughout this specification, the terms “alcohol” and “alcoholic” are intended to denote ethyl alcohol or ethyl alcohol found in all forms of comestible alcohols and alcoholic beverages. Additionally, the term “Popsicle” as used refers to any frozen confection or frozen beverage including a stick or other apparatus, either comestible or non-toxic, to hold a freestanding frozen confection or frozen beverage, not encased in any form-fitting container in order to hold its shape through distribution or during consumption.

The alcoholic Popsicle-style frozen confection or frozen beverage as herein described will preferably have a proof ranging from 2 to 40, more preferably between 4 to 28 and most preferably between 6 to 20. The percentage of alcohol employed in creating the alcoholic Popsicle-style frozen confection or frozen beverage will not only impact the freezing point of the formulation in terms of production, distribution, and storage, but will also affect its organoleptic properties. Varying the proportions of the other ingredients within the ranges specified will allow an alcoholic Popsicle-style frozen confection or frozen beverage to be produced with the appropriate degree of hardness and pleasing organoleptic properties. Though preferred embodiments of the invention will list specific proportions of ingredients, the ranges listed account for the more general case of a class of alcoholic Popsicle-style frozen confection or frozen beverage with appropriate degrees of hardness necessary for a Popsicle-style frozen confection or frozen beverage, yet may have different-but-pleasing organoleptic properties from each other.

The sweetness content of an alcoholic Popsicle-style frozen confection or frozen beverage is best expressed by soluble solids present or degrees BRIX. The product specified by this invention can vary by the types of sweeteners used, the combination of sweeteners, as well as the amount. In addition to affecting the sweetness of the product, the addition of sweetener impacts the freezing point of the product; the higher BRIX, the lower the freezing point. More complex sugars have higher molecular weights, using the BRIX measure allows for straightforward comparison between sugars employed in different formulations of the product. Because higher concentrations of sugars will depress the freezing point of the product, it must be taken into account when determining the optimum proof of a specific alcoholic Popsicle-style frozen confection or frozen beverage formulation. Examples of sweeteners include fructose, dextrose, sucrose, high fructose corn syrups, can sugar, corn sugar, corn syrup, and the like. All things being equal, higher-proof alcoholic Popsicle-style frozen confections or frozen beverages will necessarily have lower sugar content than what a lower-proof Popsicle-style frozen confection or frozen beverage can sustain. This balance between percent sugars and percent alcohol also impacts the formation of ice crystals in the final frozen Popsicle-style frozen confection or frozen beverage and will also be taken into account when determining the proper balance between sugars and alcohols. That stated the alcoholic Popsicle-style frozen confections or frozen beverages outlined typically have a BRIX rating between 2 degrees to 35 degrees BRIX, more preferably between 4 degrees to 28 degrees BRIX, and most preferably between 10 degrees and 20 degrees BRIX.

The use of a stabilizer, specifically a gum stabilizer, is crucial in the design of an alcoholic product that has physical properties that would allow it to be characterized as a Popsicle-style frozen confection or frozen beverage in addition to possessing pleasing organoleptic properties. In general stabilizers improve the stability of a water ice composition before freezing and act as a thickening agent. In more basic terms, stabilizers improve the uniformity and smoothness of the finished product and enhance the product's resistance to melting. Additionally, stabilizers retard the formation of ice crystals. As such, if a gum stabilizer were to be excluded from the formulation, the resultant frozen product would be harder than optimum for a typical Popsicle-style frozen confection or frozen beverage. Additionally, the end product would likely possess inferior organoleptic properties. The stabilizer employed can be one or a combination of the following gum stabilizers including but not limited to locust bean gum, agar-agar, xanthan gum, cellulose gum, algin-sodium alginate, propylene glycol alginate, gum acacia, guar seed gum, pectin, gum karaya, cat gum, gum tragacanth, and carrageenan. The gum stabilizer is present in an amount ranging from 0.001% to 1.0% by weight, more preferably between 0.01% to 0.5% by weight, and most preferably between 0.1% to 0.4% by weight. The precise amount used depends on the percent sugars and alcohols in the mixture as well as the organoleptic properties sought. Too much stabilizer yields a product that will be considered too rubbery, too little and the product is too hard and coarse.

An emulsifier is used to affect the texture of the alcoholic frozen confection. Specifically, an emulsifier helps mix ingredients that normally would separate, such as oil and water. To compare an emulsifier to a stabilizer, once blended with an emulsifier into an emulsion, that is, a suspension of small globules of one liquid in a second liquid with which the first will not mix, the addition of a stabilizer will prevent these ingredients from separating again. An emulsifier may be employed and can be one or a combination of the following emulsifiers including but not limited to lecithin, mono- and diglycerides, and polysorbates. The emulsifier is present in an amount ranging from 0% to 3.0% by weight, more preferably between 0.1% to 2.0% by weight, and most preferably between 0.5% to 1.0% by weight. By varying the types and amount of emulsifier employed in conjunction with varying the types and amount of stabilizer used, the organoleptic properties of the alcoholic Popsicle-style frozen product can vary dramatically yet be equally pleasing.

Flavorings are an important component to the invention. Flavoring formulations can include a combination of essential oils, natural extracts, juice concentrates, artificial flavorings and other flavoring techniques. Flavorings typically account for no more than 2.0% by weight, more preferably less than 1.0% by weight, and most preferably less than 0.5% by weight.

The use of acidulants is key in designing the flavoring characteristics as well as influencing the pH balance. Without acidulants the resulting alcoholic Popsicle® would likely be too sweet for most consumers. The change in pH associated with the use of an acidulant also impacts the effectiveness of the stabilizer to achieve optimum development of gel character and strength. Citric acid is the preferred acidulant because of its high solubility and pleasant sour taste, but other acidulants can also be employed such as malic acid, tartaric acid, fumaric acid, phosphoric acid among others. The acidulant chosen will preferably be in an amount ranging from 0.1% to 4.0% by weight, more preferably between 0.4% to 3.0% by weight and most preferably between 1.0% and 2.0% by weight. How much acidulant to use depends on the sweetness of the formulation.

The present invention will be further illustrated in the following, non-limiting Examples. The Examples are illustrative only and do not limit the claimed invention regarding the materials, conditions, process parameters and the like recited herein.

### EXAMPLE 1

This example demonstrates the preparation of a 14 proof alcoholic Lemon Drop Popsicle-style product using the following ingredients:

| Ingredient | Quantity | Units |
|---|---|---|
| Water | 106.33 | Gallons |
| Liquid Sweetener (71.5 BRIX) | 25.90 | Gallons |
| Stabilizer (CC-123) | 6.00 | Pounds |
| Ethyl alcohol (42 proof) | 67.34 | Gallons |
| LE-12067 (Natural Lemon Drop | 1.00 | Gallons |
| flavor) | | |
| Citric Acid (Anhydrous) | 13.08 | Pounds |

The procedure to prepare the Lemon Drop Popsicle-style frozen confection or frozen beverage formulation is as follows. Take 106.33 gallons of water and heat to 140° F.; combine with 6.0 pounds of stabilizer CC-123, 25.90 gallons of liquid sweetener, 67.34 gallons of 42 proof ethyl alcohol and mix well for 20 minutes. Next add 1.00 gallons of LE-12067 Natural Lemon Drop Flavor along with 13.08 pounds of anhydrous citric acid and mix well for 15 minutes: makes 200 gallons of finished liquid alcoholic Popsicle-style product mixture ready for the freezing process with BRIX of 12.0+/−0.3.

Using the prepared mixture, there are a number of conventional machines available for Popsicle-style frozen confection production. As by way of example, the process for making a one-flavor, one-color alcoholic Popsicle-style frozen confection or frozen beverage on a linear machine will be described. Alternatively, one-color, one-flavor Popsicles can be produced on a carousel machine.

The linear machine for making Lemon Drop Popsicle-style frozen confections or frozen beverages includes a series of molds arranged in parallel rows. Intermittently, the row of molds advances through the linear machine by way of a pull chain. The linear machine is divided into three sections, the inlet, freezing tank, and outlet. At the start of the production cycle, at the inlet, the prescribed liquid formulation of the Lemon Drop Popsicle-style product is injected into the molds of each of the row of molds, with the amount carefully metered. As each mold is filled, the line is intermittently advanced into the freezing tank, which is filled with brine. The exact temperature maintained in the freezing tank depends on the formulation used for alcoholic Popsicle-style frozen confections or frozen beverages. For this Lemon Drop formulation the temperature of the freezing tank is maintained at approximately −40° F. There, in the freezing tank, as the Lemon Drop Popsicle begins to solidify, a stick-inserting device inserts a stick into the mold.

At the exit of the freezing tank, the frozen Lemon Drop Popsicle-style frozen products are drawn into the outlet. At the outlet there are drawing rods which operate, intermittently under the control of a pull chain, to draw the frozen Lemon Drop Popsicle-style frozen products out of each row of molds and releases them for delivery to wrapping and packaging stations.

### EXAMPLE 2

This example demonstrates the preparation of a 14 proof Strawberry-Kiwi swirl Margarita Popsicle-style product using the following ingredients:

| Ingredient | Quantity | Units |
|---|---|---|
| Water | 106.33 | Gallons |
| Liquid Sweetener (71.5 BRIX) | 25.90 | Gallons |
| Stabilizer (CC-123) | 6.00 | Pounds |
| Ethyl alcohol (42 proof) | 67.34 | Gallons |
| Strawberry Margarita Flavor ST-11358 N & A | 0.67 | Gallons |
| Kiwi Margarita Flavor | 0.33 | Gallons |
| Citric Acid (Anhydrous) | 6.18 | Pounds |

The procedure to prepare the Strawberry Margarita Popsicle-style frozen confection or frozen beverage formulation is as follows. Take 106.33 gallons of water and heat to 140° F.; combine with 6.0 pounds of stabilizer CC-123, 25.90 gallons of liquid sweetener, 67.34 gallons of 42 proof ethyl alcohol and mix well for 20 minutes. Separate the mixture into two tanks two thirds of the mixture in one tank and one third in the other. Next, in one tank, add 0.67 gallons of ST-11358 N&A Strawberry Margarita Flavor along with 4.12 pounds of anhydrous citric acid and mix well for 15 minutes. In the other tank add 0.33 gallons of KIWI FLAVOR along with 2.06 pounds of anhydrous citric acid and mix well for 15 minutes: makes approximately 200 gallons of finished liquid, 133 gallons of Strawberry alcoholic Popsicle-style product mixture and 67 gallons of Kiwi Margarita alcoholic Popsicle-style product mixture, ready for the freezing process with BRIX of 12.0+/−0.3.

The in-line machine for making Strawberry-Kiwi swirl Margarita Popsicle-style frozen confections or frozen beverages creates a round central core of Strawberry Margarita flavor surrounding by separate spiral strips of Kiwi Margarita flavor and Strawberry Margarita flavor. A Sidam/Gram Equipment set up can be used for this purpose. Much like the machine used in the Lemon Drop example, pops are frozen in rows of vertical molds and transported through the freezing tank. In this case, each row contains say 14 molds, with the rows alternating between the cylindrical inner core mold and the spiral molds to form the swirled outside. Filling, extraction and other processes take place as rows are advanced intermittently through the system. First, the Strawberry Margarita mixture is injected into the round core molds and advances intermittently to the freezing tank, kept at approximately −40° F. Having frozen to a slush consistency, round plastic sticks are inserted into the mixture and continues through the freezing tank until frozen solid. Now frozen, the round molds pass through a hot water spray to quickly soften just the surface for the extraction process. Extractor fingers descend and pull out the round bars out of the molds and place them into the center of the spiral molds. The separate spiral sections are filled with the Kiwi Margarita mixture and Strawberry Margarita mixture.

The spiral molds are filled through small filling nozzles spaced precisely over each mold to dispense their separate contents into the spirals without spilling. The frozen Strawberry Margarita core center must be soft enough to form a tight seal against the spiral molds to prevent leaking when filled. After the spirals have been filled, the molds continue through the freezing tank to freeze the spirals. Once frozen, the molds are quickly passed through a hot spray in order to extract the swirled product from the molds. The extractors are connected to an overhead conveyor that transports the finished Strawberry-Kiwi Margarita Popsicle-style products to the wrapping and packaging stations.

It will be appreciated that additional, more complex formulations in conjunction with more complicated production processes may be employed to produce many-color, multi-layer, multi-flavored alcoholic Popsicle-style frozen confections or frozen beverages. For example, in reference to the Strawberry-Kiwi Margarita Popsicle-style product, some mold and plant setups have as many as three spirals which could allow for a four flavored alcoholic Popsicle-style frozen product, one flavor as the center core and three other flavors as spirals. Both embodiments cited above use in-line or linear type machines, alternatively, if space is limited carousel machines can be employed for similar or different formulations.

Those skilled in the art will recognize, or be able to ascertain using no more than routine experimentation, many equivalents to the specific embodiments of the invention specifically described herein. Such equivalents are intended to be encompassed in the scope of the following claims.

What is claimed is:

1. An alcoholic frozen confection or frozen beverage comprising: water, at least one sweetener, a comestible alcohol, at least one flavoring, at least one acidulant, at least one stabilizer, and optionally, one or more emulsifiers, and wherein the confection or beverage freezes between −5° F. and −50° F.

2. The alcoholic frozen confection or frozen beverage defined in claim 1 wherein the confection or beverage freezes between −15° F. and 40° F.

3. The alcoholic frozen confection or frozen beverage defined in claim 2 wherein the confection or beverage freezes between −20° F. and −30° F.

4. The alcoholic frozen confection or frozen beverage defined in claim 1 wherein the comestible alcohol is ethyl alcohol.

5. The alcoholic frozen confection or frozen beverage defined in claim 1 wherein the frozen confection or frozen beverage has a proof ranging from 2 to 40.

6. The alcoholic frozen confection or frozen beverage defined in claim 5 wherein the frozen confection or frozen beverage has a proof ranging from 4 to 28.

7. The alcoholic frozen confection or frozen beverage defined in claim 6 wherein the frozen confection or frozen beverage has a proof ranging from 6 to 20.

8. The alcoholic frozen confection or frozen beverage defined in claim 1 wherein the frozen confection or frozen beverage has a sweetness content in the range of 2 degrees to 35 degrees BRIX.

9. The alcoholic frozen confection or frozen beverage defined in claim 8 wherein the frozen confection or frozen beverage has a sweetness content in the range of 4 degrees to 28 degrees BRIX.

10. The alcoholic frozen confection or frozen beverage defined in claim 9 wherein the frozen confection or frozen beverage has a sweetness content in the range of 10 degrees to 20 degrees BRIX.

11. The alcoholic frozen confection or frozen beverage defined in claim 1 wherein the at least one acidulant is selected from the group consisting of citric acid, malic acid, tartaric acid, fumaric acid, phosphoric acid and mixtures thereof.

12. The alcoholic frozen confection or frozen beverage defined in claim 11 wherein the at least one acidulant employed ranges in amount from 0.1% to 4.0% by weight.

13. The alcoholic frozen confection or frozen beverage defined in claim 12 wherein the at least one acidulant employed ranges in amount from 0.4% to 3.0% by weight.

14. The alcoholic frozen confection or frozen beverage defined in claim 13 wherein the at least one acidulant employed ranges in amount from 1.0% to 2.0% by weight.

15. The alcoholic frozen confection or frozen beverage defined in claim 1 wherein the one or more one optional emulsifiers are selected from the group consisting of lecithin, mono- and diglycerides, polysorbates and mixtures thereof.

16. The alcoholic frozen confection or frozen beverage defined in claim 15 wherein the one or more optional emulsifiers employed range in amount from 0% to 3.0% by weight.

17. The alcoholic frozen confection or frozen beverage defined in 16 wherein the one or more optional emulsifiers employed range in amount from 0.1% to 2.0% by weight.

18. The alcoholic frozen confection or frozen beverage defined in 17 wherein the one or more optional emulsifiers employed range in amount from 0.5% to 1.0% by weight.

19. The alcoholic frozen confection or frozen beverage as defined in claim 1 wherein the one or more optional stabilizers employed are gum-based.

20. The alcoholic frozen confection or frozen beverage as defined in claim 19 wherein the gum-based stabilizers range from 0.001% to 1.0% by weight.

21. The alcoholic frozen confection or frozen beverage as defined in claim 20 wherein the gum-based stabilizers range from 0.01% to 0.5% by weight.

22. The alcoholic frozen confection or frozen beverage as defined in claim 21 wherein the gum-based stabilizers range from 0.1% to 0.4% by weight.

23. The alcoholic frozen confection or frozen beverage as defined in claim 19 wherein the gum-based stabilizers are selected from the group consisting of locust bean gum, agar-agar, xanthan gum, cellulose gum, algin-sodium alginate, propylene glycol alginate, gum acacia, guar seed gum, pectin, gum karaya, cat gum, gum tragacanth, carrageenan and mixtures thereof.

24. The alcoholic frozen confection or frozen beverage as defined in claim 1 wherein the at least one flavoring is selected from the group consisting of essential oils, natural extracts, juice concentrates, artificial flavorings and mixtures thereof.

25. The alcoholic frozen confection or frozen beverage as defined in claim 24 with the at least one flavoring ranging from no more than 2% by weight.

26. The alcoholic frozen confection or frozen beverage as defined in claim 25 with the at least one flavoring present at approximately 1% by weight or less.

27. The alcoholic frozen confection or frozen beverage as defined in claim 26 with the at least one flavoring present at approximately 0.5% by weight or less.

28. The alcoholic frozen confection or frozen beverage as defined in claim 1 wherein the frozen confection or frozen beverage further comprises a holding apparatus selected from a stick, tube and the like.

29. The alcoholic Popsicle-style water ice as defined in claim 28 wherein the holding apparatus is selected from wood, plastic and the like.

30. The alcoholic Popsicle-style water ice as defined in claim 29 wherein holding apparatus is non-toxic.

31. The alcoholic frozen confection or frozen beverage as defined in claim 1 is stable to process, transport, and store at 0° Fahrenheit or less.

32. The alcoholic frozen confection or frozen beverage as defined in claim 1 kept frozen until consumption.

33. An alcoholic frozen confection or frozen beverage comprising: water, at least one sweetener, ethyl alcohol, at least one flavoring, at least one acidulant, at least one stabilizer, and optionally, one or more emulsifiers, and wherein the confection or beverage freezes between −5° F. and −50° F.

34. An alcoholic frozen confection or frozen beverage comprising: water, at least one sweetener, ethyl alcohol, at least one flavoring, at least one acidulant, at least one stabilizer, and optionally, one or more emulsifiers, and wherein the confection or beverage freezes between −15° F. and −40° F.

35. An alcoholic frozen confection or frozen beverage comprising: water, at least one sweetener, ethyl alcohol, at least one flavoring, at least one acidulant, at least one stabilizer, and optionally, one or more emulsifiers, and wherein the confection or beverage freezes between −20° F. and −30° F.

36. An alcoholic frozen confection or frozen beverage comprising: water, at least one sweetener, ethyl alcohol, at least one flavoring, at least one acidulant, at least one stabilizer, and optionally, one or more emulsifiers, and wherein the confection or beverage freezes between −5° F. and −50° F. and comprises a holding apparatus selected from a stick, tube and the like.

37. An alcoholic frozen confection or frozen beverage comprising: water, at least one sweetener, ethyl alcohol, at least one flavoring, at least one acidulant, at least one stabilizer, and optionally, one or more emulsifiers, and wherein the confection or beverage freezes between −5° F. and −50° F.; comprises a holding apparatus selected from a stick, tube and the like; and the confection or beverage has a sweetness content in the range of 2 degrees to 35 degrees BRIX.

38. An alcoholic frozen confection or frozen beverage comprising: water, at least one sweetener, a comestible alcohol, at least one flavoring, at least one acidulant, at least one stabilizer, and optionally, one or more emulsifiers, and wherein the confection or beverage freezes between −5° F. and −50° F.; comprises a holding apparatus selected from a stick, tube and the like; and the confection or beverage has a sweetness content in the range of 2 degrees to 35 degrees BRIX.

39. An alcoholic frozen confection or frozen beverage comprising: water, at least one sweetener, ethyl alcohol, at least one flavoring, at least one acidulant, at least one stabilizer, and optionally, one or more emulsifiers, and wherein the confection or beverage freezes between −5° F. and −50° F.; comprises a holding apparatus selected from a stick, tube and the like; and the confection or beverage has a sweetness content in the range of 4 degrees to 28 degrees BRIX.
